(19) United States
(12) Patent Application Publication
(10) Pub. No.: US 2023/0113016 A1
(43) Pub. Date: Apr. 13, 2023

(54) Chroma Key Apparatus, Studio Set Comprising the Chroma Key Apparatus, Chroma Key System and Method Using the Studio Set

(71) Applicant: Sky UK Limited, Isleworth, Middlesex (GB)

(72) Inventors: Colin Bucknell, Isleworth, Middlesex (GB); Dominic Hudson, Isleworth, Middlesex (GB)

(73) Assignee: Sky UK Limited, Isleworth, Middlesex (GB)

(21) Appl. No.: 17/798,031

(22) PCT Filed: Feb. 6, 2020
(86) PCT No.: PCT/GB2020/050276

§ 371 Date: Aug. 5, 2022

(51) Int. Cl. H04N 9/75; H04N 5/275; H04N 23/86

(52) U.S. Cl. CPC H04N 9/75; H04N 5/275; H04N 23/86

(57) ABSTRACT

A chroma key screen (SL; SR) for arrangement along a side of a studio set comprises a plurality of vertically arranged louvres or slats (L), each angled in a direction (D) towards the front of the studio set. The screen (SL, SR) may appear to the studio camera to be a substantially continuous chroma key, but reflections (R) of the chroma key screen (SL; SR) from a window (W) or from objects (O) or people (P) within the studio set are reduced. This allows an improved augmented reality (AR) studio set to be created.

### FIELD OF THE INVENTION

The present invention relates to chroma key apparatus and to a method and system using that apparatus.

### BACKGROUND OF THE INVENTION

Chroma key compositing or chroma keying is a post-production technique for combining images or video content. A predetermined colour hue or chroma range is used as a chroma key in an image or video frame to determine where another image or video layer is to be inserted in a compositing process. In a studio set, the chroma key may be created using a background screen of the predetermined hue, such as green or blue, hence this technique is often referred to as ‘green screen’ or ‘blue screen’.

In television studios, chroma keying is often used to add video or computer-generated graphics to video shot in a studio set with a chroma key screen. This technique is particularly suitable for live broadcasting because the compositing can be done in real time using suitable post-production software.

One recent application of chroma keying to live broadcasting is in the coverage of football (soccer) by Sky Sports®. FIG. 1 shows an example of a studio set for this purpose, in a studio at the stadium where the football match is taking place. The back of the studio has a large window W looking onto the pitch, so that presenters or commentators P may present the match from a live setting.

Due to the spatial constraints of the stadium, the available studio space is relatively small (typically 5 m×5 m), but it is desirable that the broadcast video should appear to be from a wider studio set, of the type that viewers would normally expect in studio broadcasts. To that end, chroma key screens S_{L}, S_{R} are positioned respectively on the left and right sides of the studio set. Another chroma key screen S_{B} may be positioned in an area of the back of the studio set not occupied by the window W. Computer-generated images are then substituted for the chroma key areas during compositing. An example of a composited image is shown in FIG. 2, in which the chroma keyed areas of the video shot in the studio are replaced by augmented reality (AR) graphics AR giving the impression of a wider set on either side, and including additional graphics on the back wall of the studio set.

Details of the above prior art arrangement can be seen for example on the SVG Europe website in the news items ‘And it's live! Sky Sports to bolster Premier League coverage with more AR’ dated 29 Oct. 2018 and available on 31 Jan. 2020 at https://www.svgeurope.org/blog/headlines/and-its-live-sky-sports-to-bolster-premier-league-coverage-with-more-ar/

However, specular reflections R of the side chroma key screens S_{L}, S_{R} in the window W may be visible in the composited video, thus destroying the illusion of the AR studio set. These reflections R may be particularly visible when daylight falls through the window W onto the side chroma key screens S_{L}, S_{R}, or when the view through the window is dark so that the contrast of the reflections R is more noticeable. It may not be practicable to remove these reflections R in post-production, because the hue of the reflections R may be similar to that of parts of the view through the window W.

Another problem is that the diffuse reflected light from the chroma key screens may give an unnatural hue to any person P or object O close to the chroma key screens or may even lead to accidental chroma keying of parts of the people or objects, which constrains the positioning of people or objects within the studio set, particularly where the available studio space is narrow. In a conventional studio, people or objects should normally be positioned at least 1.5 m from a chroma key screen.

The above problems are not specific to live studio broadcasting as described above but may occur in other situations involving chroma key screen reflections.

### STATEMENTS OF THE INVENTION

According to one aspect of the present invention, there is provided a chroma key screen for arrangement along a side of a studio set, the screen comprising a plurality of substantially vertical, mutually spaced surfaces, such as louvres or slats, each angled towards the front of the studio set and therefore towards a studio camera.

At least the part of each of the surfaces that is visible to the camera is within a predetermined suitable chroma key range. An advantage of this arrangement is that the screen appears in frames shot by the studio camera(s) as a substantially continuous chroma key, which allows compositing effects such as an AR studio set to be added. Reflection of the screen from objects or people within the studio set is reduced, because the louvres are directed away from those people or objects.

Preferably, at least one of the louvres has a portion adjacent the leading edge (e.g. the edge of the louvre closest to the centre of the studio set) angled or curved slightly away from the front of the studio set. This reduces edge effects in the chroma key as seen from the camera(s), caused for example by a change of brightness at the edge of the louvres.

Preferably, the lower end of at least one of the louvres is curved or angled towards the front of the studio set, so as to reduce edge effects of the lower end. The lower end is advantageously brought closer to the louvre in front, which may then obscure the lower end.

Preferably, the width of the louvres is selected so that the screen appears to be a substantially continuous chroma key from a range of different camera positions across the front of the studio set. The width and spacing of the louvres is preferably set so that the studio lighting does not cast shadows on the visible parts of the front surfaces of the louvres. A width of at least 20 cm is preferred.

Preferably, at least one of the louvres has a lower part wider than an upper part. This may further assist in obscuring a lower edge of the louvre from the camera(s).

There may be provided means for illuminating the front faces of the louvres, preferably to avoid shadowing such as from an adjacent one of the louvres, thereby giving the chroma key a more even brightness. The means for illuminating may comprise one or more light sources, such as a light-emitting diode (LED) strip, or one or more reflectors. The one or more light sources may be mounted on or connected to the frame. Alternatively, the front faces of the louvres may be light-emitting.

The angles of the louvres may be set according to the configuration of the studio set and/or the position of the camera. Preferably, at least some of the louvres are pivotally mounted about a substantially vertical axis so that their angle may be set or adjusted. The louvres may be mounted on the frame carrying substantially vertical axles or poles about which the louvres are pivotable.

There may be provided a pair of said chroma key screens arranged on either side of the studio set. This allows compositing effects to be added to both sides of the studio set. The pair may be connected together, for example by a cross-piece extending between the chroma key screens. The cross-piece may support a further chroma key screen arranged along the back of the studio set.

A specular reflective surface such as a window may be provided at the rear of the studio. The window may allow light from outside the studio to fall onto the sides of the studio set. Preferably, a back or reverse face of at least one of the louvres is black or of a dark colour, at least for the louvre or louvres closest to the back of the studio set. Advantageously this may reduce or minimise reflection of the reverse face in the reflective surface.

According to another aspect of the present invention, there is provided a chroma key system comprising a studio set as defined above, at least one camera arranged to capture an image or video from the studio set, and a compositing system arranged to replace a chroma key part or parts of the image or video with at least one alternative image, graphic or video so as to generate a composited image or video. The system may include means for broadcasting and/or storing the composited image or video. The broadcasting is preferably live broadcasting.

According to another aspect of the invention, there is provided a method comprising capturing an image or video from the studio set, and replacing a chroma keyed part or parts of the image or video with at least one alternative image, graphic or video so as to generate a composited image or video. The composited image or video may then be stored and/or broadcasted. The broadcast is preferably live.

According to another aspect of the invention, there is provided an image or video signal or data captured from the studio set and including the chroma key.

Advantageously, this signal may include video frames showing the chroma key surfaces as substantially even and continuous chroma key areas, while exhibiting reduced chroma key reflection in other parts of the frame, and therefore embodying technical features of the invention.

### BRIEF DESCRIPTION OF THE DRAWINGS

There now follows, by way of example only, a detailed description of embodiments of the present invention, with reference to the figures identified below.

FIG. 1 shows a studio set including chroma key screens according to the state of the art.

FIG. 2 shows a composited image using a studio set similar to that of FIG. 1.

FIG. 3 shows a studio set including chroma key screen apparatus in an embodiment of the invention.

FIG. 4 shows a composited image using a studio set similar to that of FIG. 3.

FIG. 5 is a plan view of the chroma key screen apparatus in the embodiment.

FIG. 6 is a plan view of one of the louvres in the chroma key screen apparatus.

FIG. 7 is a perspective view from the front of the studio of the chroma key screen apparatus in the embodiment.

FIG. 8 is a perspective view from the front of the studio, from above and to one side, of the chroma key screen apparatus in the embodiment.

FIG. 9 is a side elevation of a chroma key screen in the embodiment.

FIG. 10 is a side elevation of a frame of the chroma key screen.

FIG. 11 is a perspective view from above and within the studio set of the chroma key screen.

FIG. 12 is perspective view from the point of view of a camera of a lower part of the chroma key screen.

FIG. 13 is a wireframe perspective diagram of a louvre of the chroma key screen.

FIG. 14 is a schematic diagram of a compositing system including the chroma key screen apparatus.

FIG. 15 is a flowchart of a method of preparing video using the chroma key screen apparatus.

FIG. 16 is a diagram of a post-production system in the embodiment of FIG. 14.

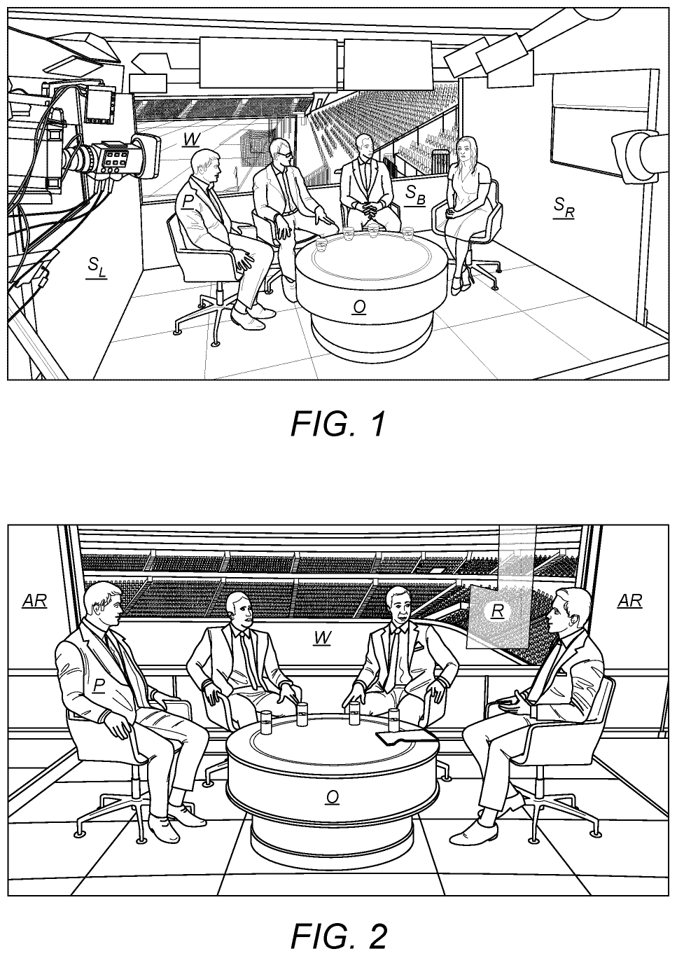

### DETAILED DESCRIPTION OF THE EMBODIMENTS

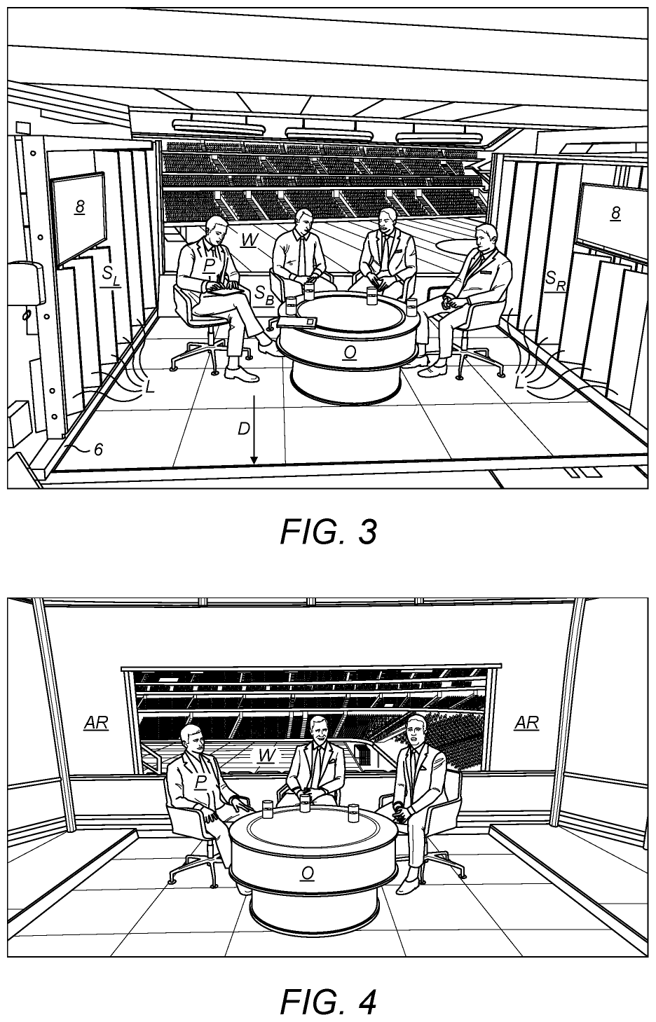

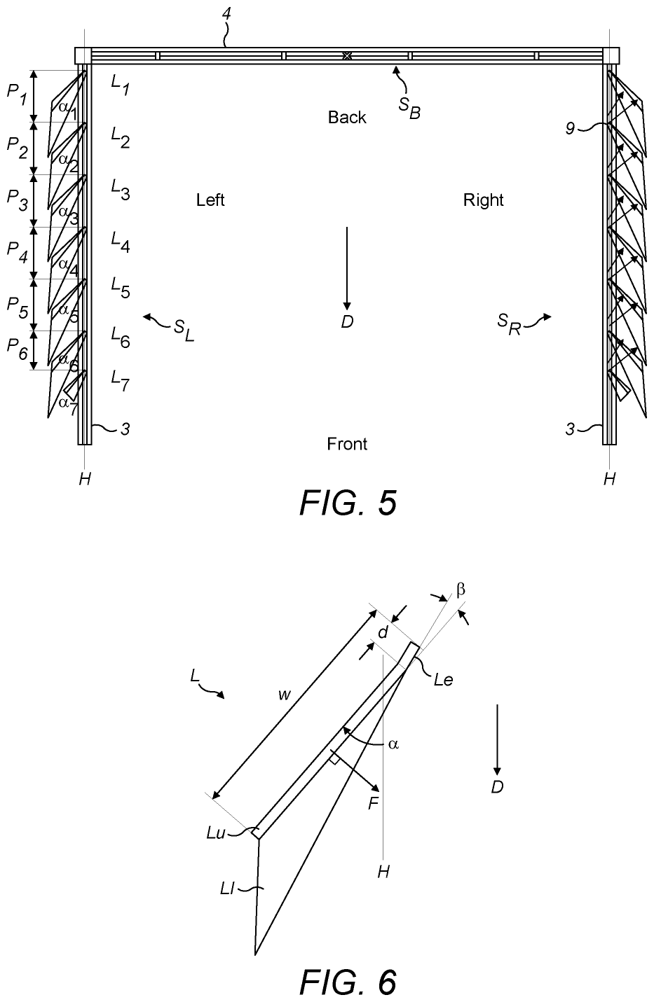

FIGS. 3 and 5 shows a studio set arrangement in one specific embodiment of the invention. As in the state of the art described above, a window W is provided in the back wall of the studio set giving a view of the pitch within the stadium, which may be lit by daylight or artificial lighting so that the pitch is visible through the window W. A section of the back wall below the window W comprises a chroma key back screen S_{B}.

In this embodiment there is provided, on each of the left and right hand sides of the studio set, respective left and right chroma key screens S_{L}, S_{R} each comprising a plurality of vertical slats or louvres L, each angled in a direction D towards the front of the studio set i.e. towards the camera(s). The louvres L are approximately rectangular in shape and elongate in the vertical direction.

FIG. 6 shows an example louvre L of the screen S_{L}, set a horizontal angle α with respect to a horizontal axis H of the left screen S_{L} i.e. the axis along which the screen S_{L} extends, which in this case is parallel to the direction D. In this embodiment the horizontal axis H is a straight line, but may in alternative embodiments be curved.

The facing direction F (i.e. a direction perpendicular to the front surface of at least the upper section Lu) of the louvre L is in the same general direction as direction D, as a result of the louvre L being angled relative to the horizontal axis H. The louvres L of the right screen S_{R} are a mirror image of the louvres L of the left screen S_{L}, about a vertical plane containing the horizontal axis H.

The front faces of the louvres L are within a chroma key range. The range may be green (e.g. with a hue in the range between 100 and 150 and most preferably approximately 120 in ICC colour profile sRGB IEC61966-2.1) or blue (e.g. with a hue in the range between 210 to 250 and most preferably between 225 and 240 in ICC colour profile sRGB IEC61966-2.1). This may be achieved using material or surface coating (e.g. paint) of the required hue. Hence, to the camera the louvres L appear as a substantially continuous chroma key area. The back or reverse faces of the louvres L are preferably black or of a dark colour so as to reduce reflections in the window W. This is preferable for the louvres L closest to the window W, but may not be necessary for louvres L positioned away from the window W, where at least part of the back or reverse faces are obscured by other, closer louvres L relative to the window W.

The louvres L are preferably made of sheet material such as plastic, metal or plywood, or fabric or material on frame, so that they can be easily fabricated and/or transported. In one embodiment, the front faces of the louvres L are of a flexible material of the required colour, attached to the frame of the louvre L. Alternative shapes may be used for the louvres: for example, the louvres may be triangular prisms.

As shown in FIG. 5, each of the chroma key screens S_{L}, S_{R} comprises an array of louvres L₁-L₇ each having a respective horizontal angle α₁₇ with respect to the horizontal axis H. The angles α₁₇ may be chosen so as to avoid or minimise gaps between the louvres L₁-L₇ as seen from the camera 10 and to avoid specular chroma key reflection from the window W and/or diffuse reflection onto any people and/or objects within the studio set. The optimum angles α₁₇ of the louvres L₁-L₇ may therefore depend on the layout of the studio set and the position of the camera(s) 10, and may be calculated in advance using a model of the studio set and/or set or modified by trial and error when setting up the studio set. However, it has been found that an optimum configuration of the louvres L₁-L₇ can be used for a wide variety of studio sizes and camera positions. For example, the angles α₁₇ of the louvres L₁-L₇ may be between 45 and 50 degrees relative to the horizontal axis H of the side wall; in one example this angle is 47 degrees. The optimum angles may vary between different ones of the louvres L₁-L₇ within the same screen S_{L}, S_{R} or may be the same for all the louvres L₁-L₇ which are therefore mutually parallel.

The dimensions and mutual spacing of the louvres L₁-L₇ may depend on the dimensions of the studio set for which they are designed. At least some of the louvres L₁-L₇ may be between 1.5 and 3 m high, corresponding substantially to the height of the studio set, although the height of some of the louvres L may be reduced to accommodate an object positioned on the side of the studio set. In one specific example, at least some of the louvres L₁-L₇ have a height h of 180 cm.

The width w of the louvres L₁-L₇ is preferably at least 20 cm. In one specific embodiment, the width w of the upper sections Lu is 45 cm. The width w may vary between different louvres L: in one example the louvre L₇ closest to the camera 10 is narrower, with a width w of 28.5 cm.

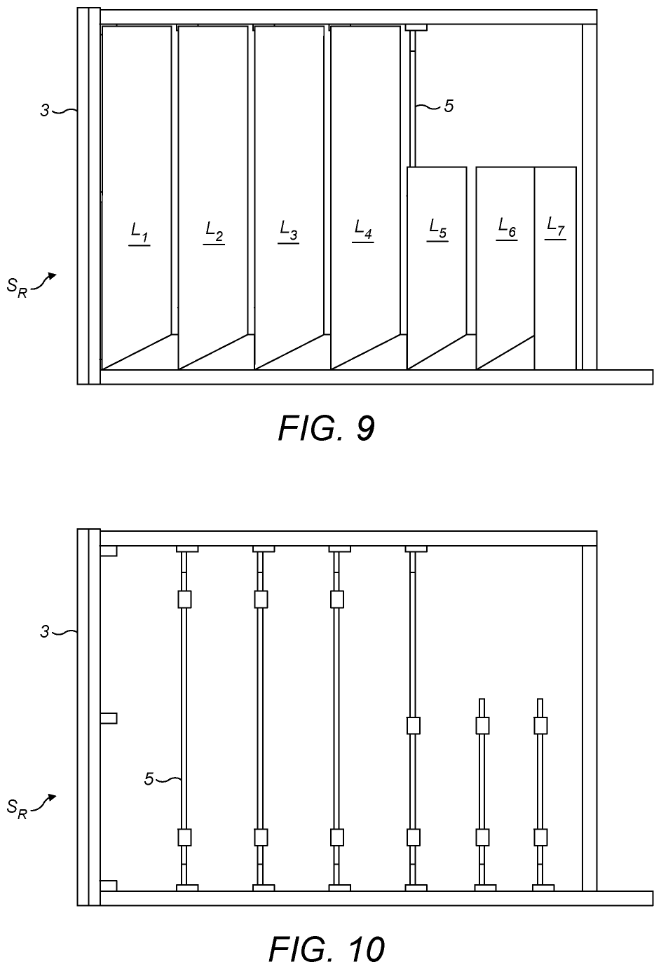

A monitor 8 may be provided within the screen S_{L}, S_{R} on either side, and one or more of the louvres L may be dimensioned (e.g. their height reduced) to accommodate the monitor 8. For example, as shown in FIGS. 3 and 7 to 11 the three louvres L₅, L₆, L₇ closest to the front of the studio set may have a shorter height h (e.g. 106 cm) so that the monitor 8 fits above them. The monitor 8 may be an ‘eye line’ monitor used to show images, video or graphics to a presenter or commentator within the studio set.

The louvres L₁-L₇ within the same screen S_{L}, S_{R} are mutually spaced apart along the axis H with a spacing or pitch P₁-P₆ that may vary between different adjacent ones of the louvres L₁-L₇. The spacing is preferably in the range 20-80 cm, or more preferably within the range 30-60 cm. In one example shown in FIG. 5, the pitch decreases in the direction D towards the front of the studio set as follows, with pitch Pₙ being from louvre Lₙ to louvre Lₙ₊₁:

| Pitch | mm |
|---|---|
| P₁ | 558 |
| P₂ | 425 |
| P₃ | 385 |
| P₄ | 385 |
| P₅ | 355 |
| P₆ | 310 |

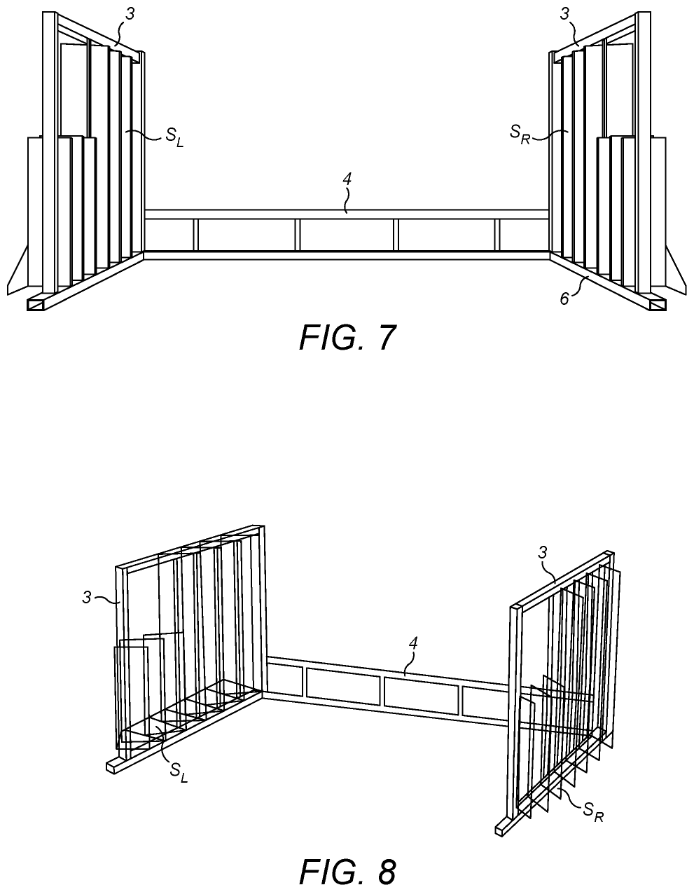

As shown in FIGS. 7 to 12, the louvres L of each screen S_{L}, S_{R} are mounted in or on a respective rectangular frame 3. In one example the frame 3 is approximately 2 m high and 2.9 m wide, in a configuration supporting seven louvres L₁-L₇.

The louvres L are preferably pivotally mounted about a substantially vertical axis in the respective frame 3, for example by attachment to a respective vertical rod or axle 5 or, in the case of the louvre L closest to the back of the studio set, to a vertical part of the frame 3 itself. The attachment may be by one or more spring clips, hinges or other means allowing rotation around the vertical rod 5, or the rod 5 itself may be rotatably mounted in the frame 3. The louvres L may be pivoted to the optimum horizontal angle α during setup of the studio set, and may be pivoted flat, or removed from the frame 3 altogether, for storage or transport.

The frames 3 on both sides may be joined together by a cross-piece 4 which supports the back screen S_{B}, thus providing a complete chroma key screen apparatus for a studio set, that is self-supporting when assembled and may be easily disassembled for transport. The dimensions of the cross-piece 4 depend on the size of the studio set: in one example, the cross-piece 4 is approximately 400 cm wide, as measured between the frames 3 on either side. The width of the cross-piece 4 may be adjustable and/or different cross-pieces 4 of different widths may be used depending on the desired width of the studio set.

The front face of each louvre L may be illuminated by a respective light source 9, such as an LED strip, and/or by a light reflector, so that the brightness of the front face is approximately even, to assist chroma keying. The respective light sources 9 and/or reflectors for the louvres L may be mounted on the corresponding frame 3. In one example, the light source for each louvre L is mounted on the vertical rod 5 of the louvre L directly in front and extends vertically over the height of the louvre L that it illuminates. A diffuser may be provided to diffuse the light emitted from the light source 9 so as to give more even illumination.

In an alternative embodiment, the front faces of the louvres L may be light-emitting. For example, they may be formed of flexible LED material such as the UNIT flexible LED display, available from Shenzhen Unit LED Co., Ltd and as disclosed for example on the following web page as of 4 Feb. 2020:

https://www.unit-led.com/product/unit-soft-flexible-series-led-display

Preferably, the colour and/or brightness of the light-emitting front faces of the louvres L may be adjusted or set to achieve a uniform chroma key.

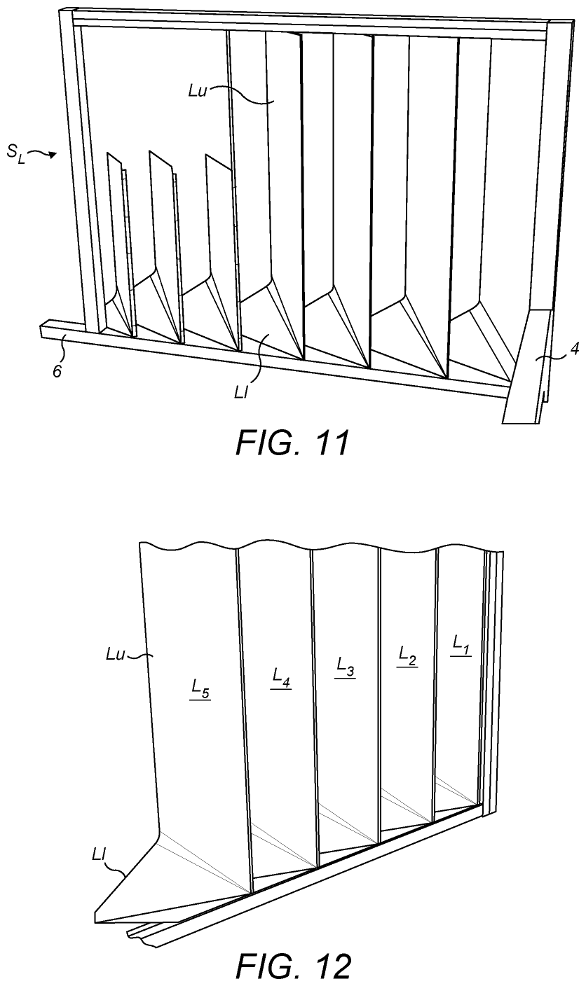

As shown in FIGS. 11 and 13, a lower section L1 of the front face of at least some of the louvres L may be flared so as to be wider than an upper section Lu of the front face of the louvre L, and/or the lower section L1 may be curved out of the plane of the upper section Lu, in the direction D towards the front of the studio set. This arrangement provides a smooth transition or ‘infinity curve’ and helps to avoid edges of the louvres L being visible to the camera. This arrangement may be achieved by a skirt of flexible fabric or material at the lower section L1. Preferably the skirt is not attached to a part of the frame of the louvre L around the transition between the upper section Lu and the lower section L1, so as to create a smooth curve. Alternatively, the frame of the louvre L may itself have a curved shape.

As shown in FIG. 13, the flared lower section L1 in one example has a height hf of 39 cm and a depth df of 42 cm, with the flared section extending across the full width w of the louvre L at the junction with the upper section Lu, tapering towards a lower outer corner of the louvre L.

As shown in FIGS. 3, 7 and 11 a lower border 6 having the required chroma is arranged along the lower edge of the frame 3, in front of the inner edges of the louvres L, thus concealing the inner edges and providing a more uniform chroma key in frames shot by the camera(s).

As shown in FIGS. 6 and 13, some or all of the louvres L may have an inner end Le (i.e. innermost to the studio set) angled out of the plane of the upper section Lu of the respective louvre L by an angle β in a horizontal direction towards the back of the studio set (i.e. opposite to direction D), so as to avoid an inner edge of the louvre L being visible to the camera(s) 10. The angle β may be between 2 and 10 degrees and in one example is 4 degrees. The horizontal width d of the inner end may be between 1 and 5 cm and in one example is 1.5 cm.

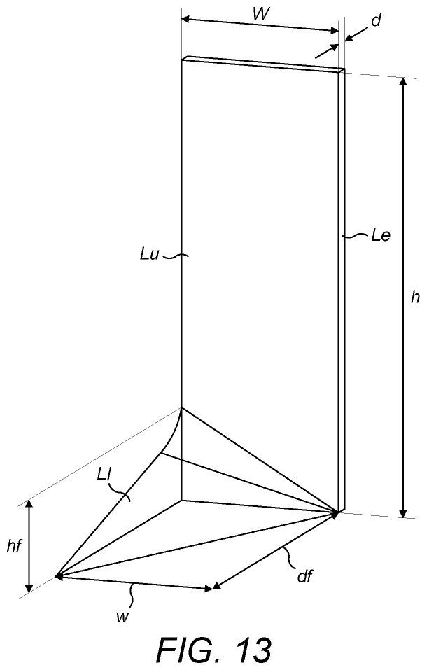

FIGS. 11 and 12 show comparative views of one of the chroma key screens S_{L} respectively from a viewpoint of a person P within the studio set and from the viewpoint of a camera 10. From the viewpoint of FIG. 11 only part of the screen S_{L} appears as a chroma key, so that chroma key reflection is reduced, while from the viewpoint of FIG. 12, the chroma key screen S_{L} appears substantially continuous, so that the resultant image or video has an even chroma key on that side of the studio set that may be replaced entirely by an alternative layer, such as the AR studio set.

As shown in FIG. 11, gaps may be visible between adjacent louvres L, from within the studio set. To avoid reflections or stray light passing through these gaps, a dark or black background may be provided behind these gaps. The background may comprise a drape or screen, or a side wall of the studio.

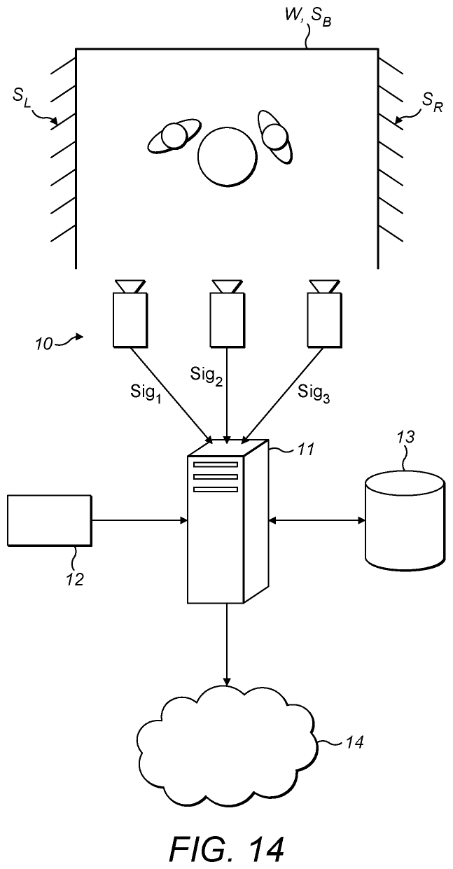

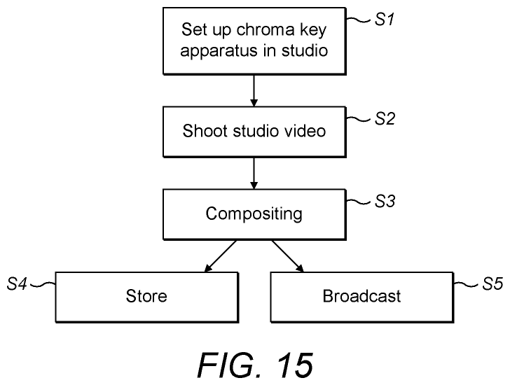

FIGS. 14 and 15 show respectively a system and method employing the above embodiment to create chroma key composited video, preferably for live broadcast.

At step S1, the chroma key apparatus, including the screens S_{L}, S_{R}, is set up in the studio as part of the studio set. This step may include setting the louvres L to the optimum angle for the studio set and the position of the camera(s). Where there are multiple cameras 10 at different positions, the louvres L may be adjusted so that the screens S_{L}, S_{R} appear as a substantially continuous chroma key area to each of the cameras.

As part of step S1, the lighting may be adjusted, including the light sources 9 illuminating the louvres L, to achieve optimum chroma keying and to minimise chroma key reflection. The lighting may be adjusted during shooting, for example as the light falling through the window W changes depending on the time of day, or the cameras 10 may be adjusted to compensate for the change in lighting.

At step S2, video is shot from the studio set using one or more cameras 10. In one example, there are three cameras 10 positioned left, centre and right in front of the studio set. The camera(s) 10 are preferably digital studio cameras that generate video signals Sig₁, Sig₂, Sig₃ in a suitable format, such as HEVC/H.265, comprising a plurality of frames that may be inter- and/or intra-frame coded.

The video signal(s) or stream(s) Sig₁, Sig₂, Sig₃ from the camera(s) 10 are input to a computer-implemented post-production system 11, comprising one or computer workstations or processors, which performs compositing at step S3 to replace chroma key areas in frames of the video signals with additional video and/or graphics, for example to create an AR studio set effect. The additional video or graphics may be provided by a secondary source 12 or may be generated within the post-production system 11. The resultant composited video is output to a content store 13 at step S4 and/or to a content delivery network 14 at step S5, from which the composited video may be broadcast or streamed. The broadcast or streaming may be live e.g. provided directly to the viewer.

The compositing may be performed with conventional post-production software and/or hardware, since the screens S_{L}, S_{R} appear in the input video frames as substantially continuous areas of substantially even brightness within the predetermined chroma range. The need to clean up the video frames to remove edges within the chroma key areas is reduced or eliminated, thus enabling real-time compositing suitable for live broadcasts.

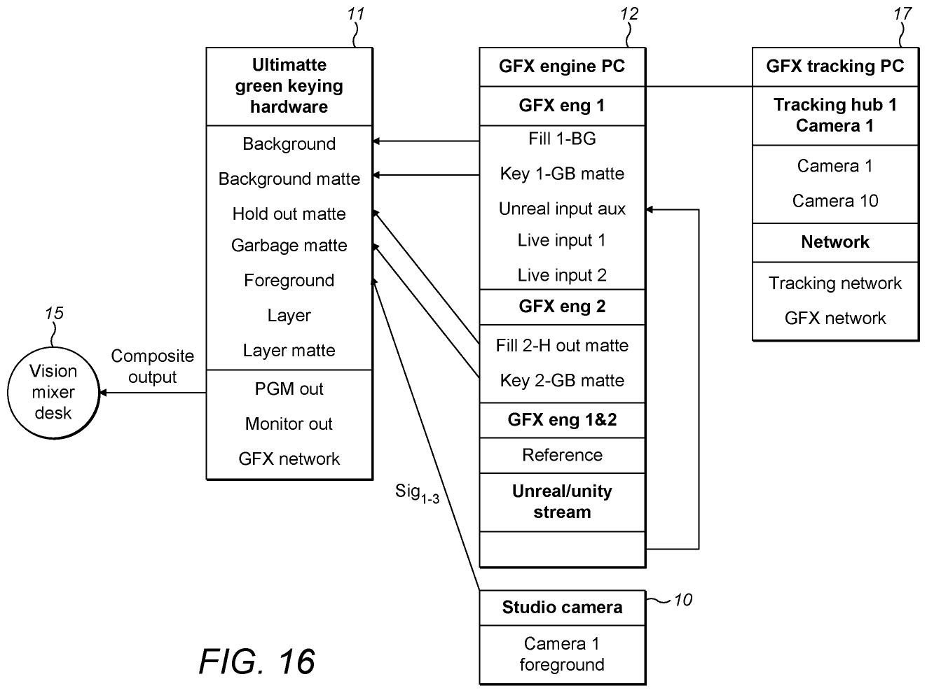

FIG. 16 shows one example of the post-production system 11, which in this example is a dedicated hardware-based chroma keying processor such as the Black Magic Ultimatte 12™ multi-definition keyer. The secondary source 12 comprises a graphics engine computer that generates the AR studio set, connected to a graphics tracking computer 17 that tracks the camera(s) 10 so as to enable the graphics engine computer to generate the corresponding view of the AR studio set. The composite output of the post-production system 11 is provided to a mixer desk 15 for mixing the video to be broadcast.

A matte may be created to prevent chroma keying of a specified part of the image, such as the window W. The matte may track the position of the specified part as it moves within the image.

During compositing, the position of the monitor 8 may be determined and the monitor 8 may be removed from the image. Preferably a virtual monitor is shown in the AR studio set along the same eye line as the monitor 8 so that the presenter or commentator appears to be looking at the virtual monitor.

### ALTERNATIVE EMBODIMENTS

Alternative embodiments may be envisaged on reading the present application, which nevertheless fall within the scope of the following claims. For example, although the chroma key surfaces are shown in specific embodiments as being mounted on or forming part of discrete louvres or slats, other arrangements may be envisaged which nevertheless provide the required arrangement of chroma key surfaces. For example, the chroma key surfaces may form part of a continuous folded structure comprising the chroma key screen.

1. A chroma key screen apparatus for arrangement along a side of a studio set, the apparatus comprising a plurality of substantially vertical surfaces arranged along a horizontal axis, each said surface being arranged at a respective horizontal angle with respect to the horizontal axis, in the same horizontal direction; wherein at least a visible portion of each said surface is within a chroma key range.

2. The apparatus of claim 1, wherein at least one of the surfaces has an inner end portion angled or curved in an opposite direction to the horizontal direction in which the surfaces are angled.

3. The apparatus of claim 1, wherein at least one of the surfaces has a lower portion that is angled or curved out of a plane of an upper portion thereof, in said horizontal direction.

4. The apparatus of claim 1, wherein at least one of the surfaces has a lower portion having a horizontal width greater than that of an upper portion thereof.

5. The apparatus of claim 1, wherein at least one of the surfaces has a horizontal width of at least 20 cm.

6. The apparatus of claim 1, wherein at least one of the surfaces has a respective light source and/or light reflector arranged to illuminate that surface.

7. The apparatus of claim 1, wherein at least one of the surfaces is arranged to emit light.

8. The apparatus of claim 1, wherein the horizontal angle of at least one of the surfaces is adjustable.

9. The apparatus of claim 1, wherein said horizontal angle is between 45 and 50 degrees.

10. The apparatus of claim 1, wherein said plurality of surfaces are discrete and mutually spaced apart.

11. The apparatus of claim 10, wherein at least one of the plurality of surfaces has a dark reverse surface.

12. The apparatus of claim 10, wherein the spacing along the horizontal axis between adjacent ones of said surfaces is in the range 20-80 cm.

13. The apparatus of claim 1, comprising a corresponding plurality of louvres or slats having front faces which comprise respectively said plurality of surfaces.

14. The apparatus of claim 13, wherein the louvres or slats are mounted on or in a frame.

15. The apparatus of claim 14, wherein the horizontal angle of at least one of the surfaces is adjustable and wherein the frame includes a respective vertical pivot for the or each said louvre or slat that has an adjustable horizontal angle.

16. The apparatus of claim 14, wherein at least one of the surfaces has a respective light source and/or light reflector arranged to illuminate that surface, and wherein the light source and/or light reflector is mounted on or connected to the frame.

17-19. (canceled)

20. A studio set including the chroma key screen apparatus of claim 1, wherein the chroma key screen apparatus is arranged along a side of the studio set.

21-22. (canceled)

23. A system comprising:
a. the studio set of claim 20;
b. at least one camera arranged to capture an image and/or video from the studio set; and
c. one or more computer processors arranged to perform chroma key processing of the image and/or video.

24. A method comprising:
a. capturing an image and/or video from the studio set of claim 20; and
b. performing computer-implemented chroma key processing of the image and/or video.

25-26. (canceled)
